(19) United States
(12) Patent Application Publication
(10) Pub. No.: US 2020/0112063 A1
(43) Pub. Date: Apr. 9, 2020

(54) MANUFACTURING METHOD OF SOLID-STATE BATTERY

(71) Applicant: Honda Motor Co.,Ltd., Tokyo (JP)

(72) Inventors: Ushio HARADA, Saitama (JP); Hiroto MAEYAMA, Saitama (JP); Wataru SHIMIZU, Saitama (JP); Atsushi OGAWA, Saitama (JP); Masahiro OHTA, Saitama (JP); Soshi KAWAMURA, Saitama (JP)

(73) Assignee: Honda Motor Co.,Ltd., Tokyo (JP)

(21) Appl. No.: 16/595,472

(22) Filed: Oct. 8, 2019

(30) Foreign Application Priority Data
Oct. 9, 2018 (JP) 2018-191151

(51) Int. Cl. H01M 10/0585; H01M 4/04; H01M 4/139

(52) U.S. Cl. CPC H01M 10/0585; H01M 2300/0068; H01M 4/139; H01M 4/043

(57) ABSTRACT

A manufacturing method of solid-state battery capable of more effectively preventing a short circuit between electrode layers is provided. The manufacturing method of a solid-state battery 1 includes: a laminate pressing process for pressing a laminate 10a in which a positive electrode layer 11a, a negative electrode layer 13a, and a solid electrolyte layer 12a between the positive electrode layer 11a and the negative electrode layer 13a are laminated; and a shearing process for punching the laminate 10a into a prescribed shape by shearing to form a plurality of single battery components 10.

### CROSS-REFERENCE TO RELATED APPLICATION

This application claims the priority of Japan patent application serial no. 2018-191151, filed on Oct. 9, 2018. The entirety of the above-mentioned patent application is hereby incorporated by reference herein and made a part of this specification.

### BACKGROUND OF THE DISCLOSURE

### Technical Field

The disclosure relates a manufacturing method of solid-state battery.

### Related Art

In recent years, due to the popularity of various large or small electrical and electronic devices such as cars, personal computers, mobile phones and the like, the demand for a battery with high capacity and high output expands rapidly. For example, compared with a conventional battery with an organic electrolytic solution as an electrolyte, a solid-state battery with a solid electrolyte is excellent in terms of an improvement of safety due to non-combustibility of the electrolyte or in terms of having a higher energy density, and currently attracts attention (for example, see patent literature 1).

Since the solid electrolyte is used in the solid-state battery, a pressing process using a pressing machine is performed after a laminate is formed from the viewpoint of a good interface bonding between an electrode and an electrolyte layer or densification of the electrolyte layer itself. Then, a cutting process for cutting the laminate into a prescribed shape to obtain a plurality of single batteries is performed. Specifically, a plurality of single battery components are formed by lowering a cutting blade to the laminate in which the solid electrolyte layers are laminated. However, when the laminate is cut off, on the surface to be cut first, the cutting surface deforms due to a force applied from the cutting blade in the cutting direction, and a short circuit may occur between the electrode layers.

Therefore, for example in patent literature 2, a manufacturing method of solid-state battery is disclosed in which two cutting blades disposed on the surface side of one current-collecting foil and the surface side of the other current-collecting foil are engaged with each other in the manner of contacting in the electrolyte layer to cut off the laminate. According to this manufacturing method of solid-state battery, a short circuit between electrode layers can be suppressed.

### LITERATURE OF RELATED ART

### Patent Literature

[Patent literature 1] Japanese Laid-Open No. 2017-147158

[Patent literature 2] Japanese Laid-Open No. 2014-127260

The inventors have studied intensively to solve the above problems and found that the above problems can be solved by punching the laminate into a prescribed shape by shearing to form a plurality of single battery components.

### SUMMARY

However, in the manufacturing method of solid-state battery described in patent literature 2, the state before blade surfaces of the cutting blades are in contact in the solid electrolyte layer (for example, when the cutting blades pass through the current-collecting foil) is simply a state in which the cutting blades are inserted. The cutting surface cut in this state cannot effectively prevent a short circuit. Particularly, when the solid electrolyte layer is thinned for the purpose of improving the volume energy density of a solid-state battery module, the risk of short circuit of the cutting surface is further increased.

The disclosure provides a manufacturing method of solid-state battery capable of more effectively preventing a short circuit between electrode layers.

A first aspect of the disclosure provides a manufacturing method of solid-state battery which includes: a laminate pressing process for pressing a laminate in which a positive electrode layer, a negative electrode layer, and a solid electrolyte layer between the positive electrode layer and the negative electrode layer are laminated; and a shearing process for punching the laminate into a prescribed shape by shearing to form a plurality of single battery components.

A current-collecting foil bonding process for bonding a current-collecting foil to the positive electrode layer and the negative electrode layer in the single battery component may be further included.

### BRIEF DESCRIPTION OF THE DRAWINGS

FIG. 1 is a cross-section view of a single battery component 10 of an embodiment.

FIG. 2 is a flowchart showing a flow of a manufacturing method of a solid-state battery 1 of the embodiment.

FIG. 3 is a schematic diagram of shearing used in a shearing process SP2 of the embodiment.

FIG. 4 is a concept diagram of the shearing process SP2 for punching a laminate 10a into a prescribed shape by shearing to form a plurality of single battery components 10.

FIG. 5 is a cross-section view of the solid-state battery 1 of the embodiment.

FIG. 6 is a cross-section view of a solid-state battery 2 of another embodiment of the disclosure.

### DESCRIPTION OF THE EMBODIMENTS

Specific embodiments of the disclosure are described below in detail, but the disclosure is not limited to the following embodiments, and appropriate modifications can be made within the scope of the purpose of the disclosure.

According to the disclosure, a short circuit between the electrode layers can be more effectively prevented.

<Manufacturing Method of Solid-State Battery>

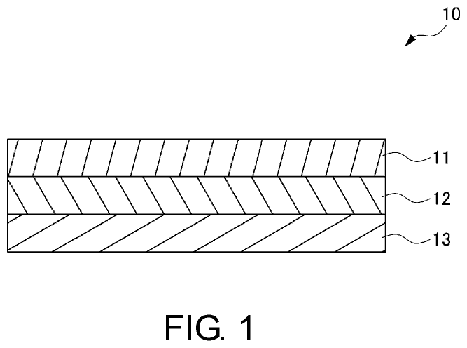

FIG. 1 is a cross-section view showing an outline of a single battery component 10 of the embodiment. The single battery component 10 is a laminate which includes a positive electrode layer 11, a solid electrolyte layer 12, and a negative electrode layer 13. In addition, the single battery component 10 is punched into a prescribed shape as described later.

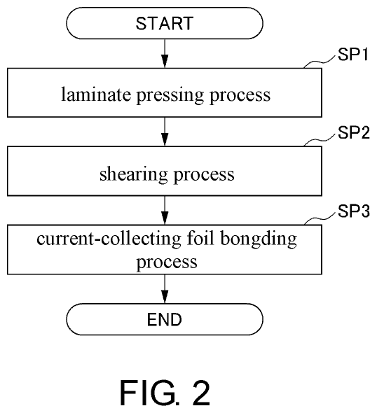

FIG. 2 is a flowchart showing a flow of a manufacturing method of a solid-state battery 1 of the embodiment. The manufacturing method of the solid-state battery 1 of the embodiment can be, for example, a manufacturing method of solid-state battery which includes: a laminate pressing process SP1 for pressing a laminate 10a in which a positive electrode layer 11a, a negative electrode layer 13a, and a solid electrolyte layer 12a between the positive electrode layer 11a and the negative electrode layer 13a are laminated; a shearing process SP2 for punching the laminate 10a into a prescribed shape by shearing to form a plurality of single battery components 10; and a current-collecting foil bonding process SP3 for bonding a current-collecting foil to the positive electrode layer 11 and the negative electrode layer 13 in the single battery component 10. Each process is described below.

[Laminate Pressing Process]

The laminate pressing process is a process for pressing the laminate 10a in which the positive electrode layer 11a, the negative electrode layer 13a, and the solid electrolyte layer 12a between the positive electrode layer 11a and the negative electrode layer 13a are laminated. Besides, the laminate 10a may have other layers laminated therein.

Adhesion of each layer is improved by pressing the laminate 10a. Pressing means can be a general method such as uniaxial or biaxial pressing, roll-pressing or the like. A pressure during pressing is preferably applied for pressing until the interface of each layer is bonded and the solid electrolyte layer becomes tight. Each layer constituting the laminate 10a is described below.

(Positive Electrode Layer)

The positive electrode layer 11a is a layer which includes a layer containing at least a positive-electrode active material and a positive-electrode current collector. The material capable of releasing and occluding a charge-transfer medium may be appropriately selected to be used as the positive-electrode active material. From the viewpoint of improving the charge-transfer medium conductivity, a solid electrolyte may be included arbitrarily. In addition, in order to improve the electrical conductivity, a conductive auxiliary may be included arbitrarily. Furthermore, from the viewpoint of exhibiting the flexibility and the like, a binder may be included arbitrarily. The solid electrolyte, the conductive auxiliary and the binder which are generally used in the solid-state battery can be used.

The positive-electrode active material can be similar to the material used in the positive electrode layer of the general solid-state battery and is not particularly limited. For example, if the solid-state battery is a lithium-ion battery, the positive-electrode active material may be a layered active material containing lithium, a spinel-type active material containing lithium, an olivine-type active material containing lithium, and the like. Specific examples of the positive-electrode active material may be lithium cobaltate (LiCoO₂), lithium nickelate (LiNiO₂), LiNiₚMn_{q}CoᵣO₂ (p+q+r=1), LiNi_{P}Al_{q}CoᵣO₂ (p+q+r=1), lithium manganate (LiMn₂O₄), heterogeneous element substituted Li—Mn spinel represented by Li₁₊ₓMn_{2-x-y}M_{y}O₄ (x+y=2, M is at least one element selected from Al, Mg, Co, Fe, Ni, and Zn), lithium titanate (an oxide containing Li and Ti), lithium metal phosphate (LiMPO₄, M is at least one element selected from Fe, Mn, Co, and Ni), and the like.

The positive-electrode current collector is not particularly limited as long as the positive-electrode current collector has a function for performing current collection of the positive electrode layer, and may be, for example, aluminum, aluminum alloy, stainless steel, nickel, iron, titanium, and the like, among which aluminum, aluminum alloy and stainless are preferable. In addition, the shape of the positive-electrode current collector may be, for example, a foil shape, a plate shape and the like.

(Manufacturing Method of Positive Electrode Layer)

The positive electrode layer 11a can be manufactured by disposing a positive-electrode mixture containing the positive-electrode active material on the surface of the positive-electrode current collector. The manufacturing method of positive electrode may be the same method as before, and the positive electrode can be manufactured by any one of a wet method and a dry method. A case of manufacturing the positive electrode by the wet method is described below.

The positive electrode layer 11a is manufactured by a process in which a positive-electrode mixture paste containing a positive-electrode mixture and a solvent is obtained, and a process in which the positive-electrode mixture paste is coated on the surface of the positive-electrode current collector and dried to form a positive-electrode mixture layer on the surface of the positive-electrode current collector. For example, the positive-electrode mixture paste is obtained by mixing and dispersing the positive-electrode mixture in the solvent. The solvent used in this case is not particularly limited and may be selected appropriately corresponding to properties of the positive-electrode active material, the solid electrolyte or the like. For example, nonpolar solvents such as heptane and the like are preferable. Various mixing-dispersing devices such as an ultrasonic dispersion device, a shaking apparatus, FILMIX (registered trademark) and the like can be used in mixture and dispersion of the positive-electrode mixture and the solvent. The solid content of the positive-electrode mixture paste is not particularly limited.

The positive electrode layer 11a can be obtained by coating and drying the positive-electrode mixture paste obtained in this way on the surface of the positive-electrode current collector to form the positive-electrode mixture layer on the surface of the positive-electrode current collector. The means for coating the positive electrode paste on the surface of the positive-electrode current collector may be a well-known coating means such as a doctor blade or the like. A total thickness (a thickness of the positive electrode) of the dried positive-electrode mixture layer and positive-electrode current collector is not particularly limited, but from the viewpoint of energy density or stackability for example, the total thickness is preferably 0.1 μm or more and 1 mm or less, more preferably 1 μm or more and 100 μm or less. In addition, the positive electrode may be manufactured through a process of pressing arbitrarily. In addition, the positive electrode layer may be manufactured by coating and drying the positive-electrode mixture paste on the surface of a resin film to form the positive-electrode mixture layer and releasing the resin film. In this case, it is preferable to coat a mold-release agent on the resin film in advance.

(Negative Electrode Layer)

The negative electrode layer 13a is a layer which includes a layer containing at least a negative-electrode active material and a negative-electrode current collector. From the viewpoint of improving the charge-transfer medium conductivity, a solid electrolyte may be included arbitrarily. In addition, in order to improve the electrical conductivity, a conductive auxiliary may be included arbitrarily. Furthermore, from the viewpoint of exhibiting the flexibility and the like, a binder may be included arbitrarily. The solid electrolyte, the conductive auxiliary and the binder which are generally used in the solid-state battery can be used.

The negative-electrode active material is not particularly limited as long as this negative-electrode active material can release and occlude a charge-transfer medium; for example, if the solid-state battery is a lithium-ion battery, the negative-electrode active material may be a lithium transition metal oxide such as lithium titanate (Li₄Ti₅O₁₂), a transition metal oxide such as TiO₂, Nb₂O₃, WO₃ and the like, a metal sulfide, a metal nitride, carbon materials such as graphite, soft carbon, hard carbon and the like, metallic lithium, metallic indium, lithium alloy and the like. In addition, the negative-electrode active material may be in the shape of powder or thin film.

The negative-electrode current collector is not particularly limited as long as the negative-electrode current collector has a function for performing current collection of the negative electrode layer 13a. Materials of the negative-electrode current collector may be, for example, nickel, copper, stainless steel, and the like. In addition, the shape of the negative-electrode current collector may be, for example, a foil shape, a plate shape and the like.

(Manufacturing Method of Negative Electrode Layer)

Similar to the positive electrode layer 11a, for example, the negative electrode layer 13a can be produced through the following process in which a negative-electrode mixture paste is produced by putting the negative-electrode active material and the like into a solvent and then using an ultrasonic dispersion device or the like to disperse the solution, and the negative-electrode mixture paste is coated on the surface of the negative-electrode current collector and dried. The solvent used in this case is not particularly limited and may be selected appropriately corresponding to properties of the negative-electrode active material and the like. A thickness of the negative electrode layer 13a is, for example, preferably 0.1 μm or more and 1 mm or less, more preferably 1 μm or more and 100 μm or less. In addition, the negative electrode can be manufactured through the process of pressing. The negative electrode layer may also be manufactured by coating and drying the negative-electrode mixture paste on the surface of a resin film to form the negative-electrode mixture layer, and releasing the resin film. In this case, it is preferable to coat a mold-release agent on the resin film in advance.

(Solid Electrolyte Layer)

The solid electrolyte layer 12a is a layer laminated between the positive electrode layer 11a and the negative electrode layer 13a, and is a layer including at least a solid electrolyte material. A charge-transfer medium conduction between the positive-electrode active material and the negative-electrode active material can be performed via the solid electrolyte material included in the solid electrolyte layer 12a.

The solid electrolyte material is not particularly limited as long as the material has the charge-transfer medium conductivity, and the solid electrolyte material may be, for example, a sulfide solid electrolyte material, an oxide solid electrolyte material, a nitride solid electrolyte material, a halide solid electrolyte materials and the like, among which the sulfide solid electrolyte material is preferable. This is because the sulfide solid electrolyte material has a higher charge-transfer medium conductivity than the oxide solid electrolyte material.

When the solid-state battery is a lithium-ion battery for example, the sulfide solid electrolyte material may be Li₂S—P₂S₅, Li₂S—P₂S₅—LiI and the like. Besides, the description of the “Li₂S—P₂S₅” refers to the sulfide solid electrolyte material formed by using a raw material composition including Li₂S and P₂S₅, and the same applies to other descriptions.

On the other hand, when the solid-state battery is a lithium-ion battery for example, the oxide solid electrolyte material may be a NASICON-type oxide, a garnet-type oxide, a perovskite-type oxide and the like. The NASICON-type oxide may be, for example, an oxide containing Li, Al, Ti, P and O (for example, Li_{1.5}Al_{0.5}Ti_{1.5}(PO₄)₃). The garnet-type oxide may be, for example, an oxide containing Li, La, Zr and O (for example, Li₇La₃Zr₂O₁₂). The perovskite-type oxide may be, for example, an oxide containing Li, La, Ti and O (for example, LiLaTiO₃).

(Manufacturing Method of Solid Electrolyte Layer)

The solid electrolyte layer 12a can be manufactured through, for example, a process of pressing the solid electrolyte and the like. Alternatively, the solid electrolyte layer can also be manufactured through a process of coating, on the surface of a substrate or an electrode, a solid electrolyte paste which is prepared by dispersing the solid electrolyte and the like in a solvent. The solvent used in this case is not particularly limited and may be appropriately selected corresponding to properties of the binder or the solid electrolyte. The thickness of the solid electrolyte layer varies greatly depending on the configuration of the battery, and the thickness is, for example, preferably 0.1 μm or more and 1 mm or less, more preferably 1 μm or more and 100 μm or less.

[Shearing Process]

The shearing process is a process for punching the laminate 10a into a prescribed shape by shearing to form a plurality of single battery components 10.

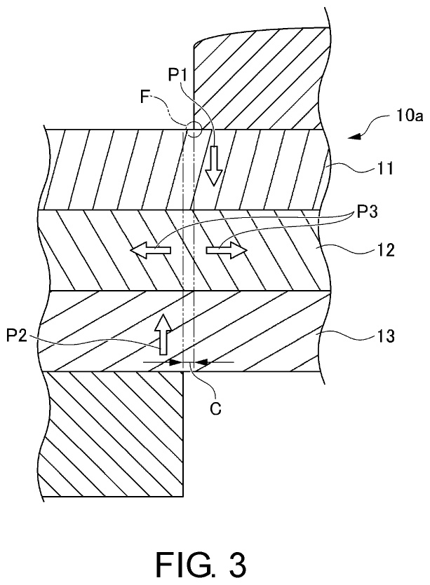

In FIG. 3, a schematic diagram of shearing is shown. The laminate 10a is clamped by a punch 2 and a die 4 as shown in FIG. 3. Then, a force P1 is applied downward to the punch 2 by a pressing machine and the like from the upper surface of the laminate 10a. Accordingly, in the laminate 10a, the lower surface of the laminate 10a is suppressed by the die 4 and a reaction force P2 acts. Then, by the force P1 and the force P2, a tension force P3 acts in a surface direction of the laminate 10a. When the laminate 10a cannot withstand the tension force P3, the laminate 10a is fractured from a force point f.

The fracture surface of the laminate 10 becomes a smooth surface due to the punch 2 caving into the laminate 10a. Accordingly, the possibility of generation of burrs on the fracture surface can be reduced, and a short circuit between the electrode layers can be more effectively prevented.

For example, according to the study of the inventors, it is clear that burrs are generated on the fracture surface when the cutting blade is used to cut off the laminate 10a and thus a short circuit occurs between the electrode layers of the single battery component 10. The reason is that the cutting blade has a prescribed thickness and a laminate part corresponding to the thickness of the cutting blade becomes a bur when the cutting blade is inserted into the laminate 10a, thereby causing a short circuit between the electrode layers.

The manufacturing method of the solid-state battery 1 of the embodiment is characterized in that the laminate 10a is punched into a prescribed shape by shearing to form a plurality of single battery components 10. Accordingly, compared with a case of cutting off the laminate 10a by the cutting blade, the possibility of generation of burrs on the fracture surface can be reduced. In addition, by punching into a prescribed shape by shearing, the surface of the positive electrode layer 11 and the surface of the negative electrode layer 13 are approximately the same in area. Therefore, there is also an effect that the plurality of single battery components 10 can be arranged without clearance in a current-collecting foil bonding process described later.

The magnitude of the force P1 applied downward to the punch 2 from the upper surface of the laminate 10a varies depending on the thickness or area of the laminate 10a and the size of a clearance C, but is preferably a pressure exceeding the pressure for laminating the laminate 10a; for example, the force P1 is preferably a force of 100 kg or more, more preferably a force of 200 kg or more. The magnitude of the force P1 is preferably 5000 kg or less, further preferably 3000 kg or less.

Besides, a ratio of the distance of the clearance C between the punch 2 and the die 4 with respect to the thickness of the laminate 10a which is represented by a ratio of the clearance C/the thickness of the laminate 10a is preferably 1/300 or more, more preferably 1/200 or more. By the ratio being 1/300 or more, the possibility of wear caused by the contact of the punch 2 and the die 4 can be reduced. The ratio of the clearance C/the thickness of the laminate 10a is preferably 1/10 or less, more preferably 1/20 or less. The possibility of generation of burrs on the fracture surface can be more effectively reduced.

The shearing can be performed by conventionally-known method and may be, for example, punching and the like.

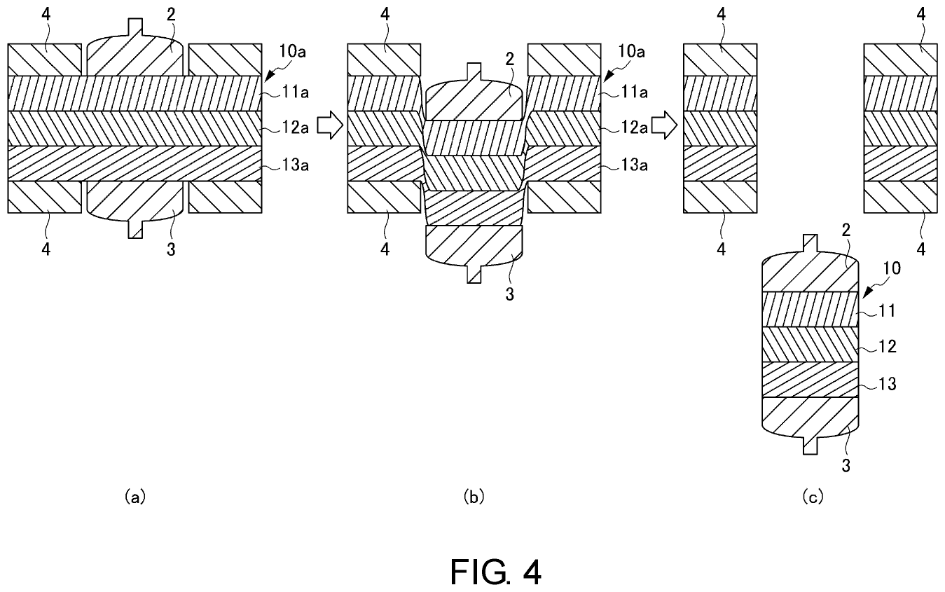

FIG. 4 shows a concept diagram of the shearing process for punching the laminate 10a into a prescribed shape by shearing to form a plurality of single battery components 10. Firstly, the laminate 10a is clamped by the punches 2, 3 and the die 4 as shown in FIG. 4(a), and a force is applied downward from the punch 2 side (the upper surface) by the pressing machine and the like. Then, a tension force acts on the laminate 10a due to the punches 2, 3 and the die 4. When the laminate 10a cannot withstand the tension force, the laminate 10a is torn up (FIG. 4(b)), and the laminate 10a and the single battery component 10 are separated (FIG. 4(c)). Accordingly, the laminate 10a can be punched into a prescribed shape to form a plurality of single battery components 10.

Besides, it is preferable to form an insulation film on the cutting surface of the single battery component 10 which is punched into a prescribed shape by shearing. A short circuit between the electrode layers can be more effectively prevented.

[Current-Collecting Foil Bonding Process]

The current-collecting foil bonding process is a process for forming a current-collecting foil by applying a paste on the positive electrode layer 11 and the negative electrode layer 13 in the single battery component 10.

Specifically, for the plurality of single battery parts 10 obtained by the above shearing process, the positive electrode layers or the negative electrode layers are overlapped to arrange the plurality of single battery components. Then, an adhesive paste is applied between the electrode layers to bond the current-collecting foil.

Besides, preferably, in the current-collecting foil, an insulation film is coated in advance on the surface not in contact with the electrode layers. A short circuit can be more effectively prevented.

<Solid-State Battery>

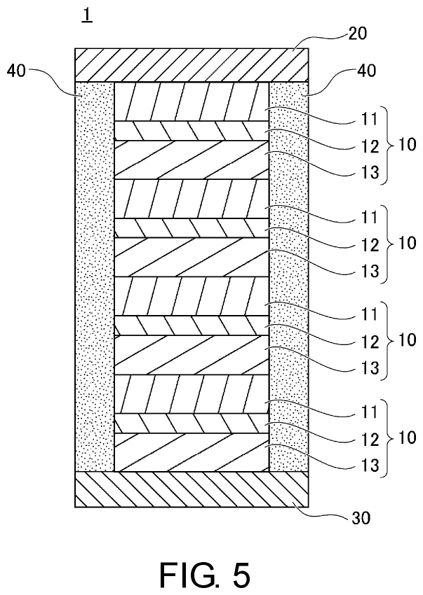

FIG. 5 is used to describe one example of the solid-state battery which is manufactured by the plurality of single battery components manufactured by the above processes. The solid-state battery 1 is a solid-state battery 1 having a so-called bipolar structure in which the plurality of single battery components 10 are arranged in series. Then, the adhesive paste is applied to the top and the bottom of a laminate obtained by laminating the single battery components 10 to bond the current-collecting foils 20, 30. Accordingly, a solid-state battery with voltage is formed. Then, the insulation film 40 is coated on an end portion of the laminate of each single battery component 10. Accordingly, a short circuit can be more effectively prevented.

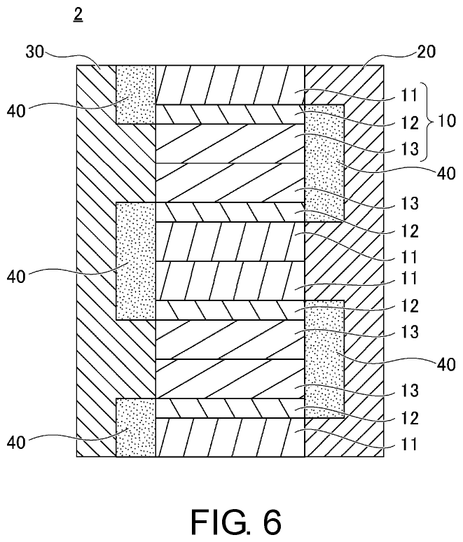

FIG. 6 is used to describe another example of the solid-state battery which is manufactured by the plurality of single battery components manufactured by the above processes. The solid-state battery 2 is a parallel-lamination-type solid-state battery, an end portion of the negative electrode layer 13 is connected to the negative-electrode current-collecting foil 30, and an end portion of the positive electrode layer 11 is connected to the positive-electrode current-collecting foil 20. By connecting the respective solid batteries in parallel, a solid-state battery with high capacity can be obtained.

What is claimed is:

1. A manufacturing method of solid-state battery, comprising: a laminate pressing process for pressing a laminate in which a positive electrode layer, a negative electrode layer, and a solid electrolyte layer between the positive electrode layer and the negative electrode layer are laminated; and
a shearing process for punching the laminate into a prescribed shape by shearing to form a plurality of single battery components.

2. The manufacturing method of solid-state battery according to claim 1, further comprising a current-collecting foil bonding process for bonding a current-collecting foil to the positive electrode layer and the negative electrode layer in the single battery component.
